(19) United States
(12) Patent Application Publication
(10) Pub. No.: US 2009/0037810 A1
(43) Pub. Date: Feb. 5, 2009

(54) Graphical data mapping technique

(75) Inventor: Cherif Atia Algreatly, Newark, CA (US)

Correspondence Address: CHERIF ATIA ALGREATLY;MATHEMATICAL INVENTING - SILICON VALLEY, SUITE 286, 39962 CEDAR BLVD, NEWARK, CA, 94560, US

(73) Assignee: CHERIF ATIA ALGREATLY, NEWARK, CA (US)

(21) Appl. No.: 12/072,976

(22) Filed: Feb. 29, 2008

Related U.S. Application Data
(60) Provisional application No. 60/904,964, filed on Mar. 5, 2007.

(51) Int. Cl. G06F 17/00

(52) U.S. Cl. 715/247

(57) ABSTRACT

A graphical data mapping technique that enables the computer system to recognize and analyze the presented graphical data on the computer display including the images, drawings, 3D modeling, or the like. Said graphical data mapping technique converts the graphical data into a number of matrices where the computer system can extract the needed information about said graphical data from the formed matrices serving various medical, engineering, industrial, and IT applications.

### CROSS-REFERENCE TO RELATED APPLICATION

This application is a Continuation-in-Part of co-pending U.S. Provisional Application No. 60/904,964, filed Mar. 5, 2007.

### BACKGROUND

The medical, engineering, industrial, and IT fields are some examples of various fields that utilize the computer display to present graphical information such as pictures, images, or drawings for the purpose of analysis, design, or interaction.

In essence, when the computer displays said graphical information, it perceives it mainly as raw data in the form of coordinates along the Cartesian plane.

This is in contrast to how humans perceive graphical data; they see it as information, or data in its usable form that is processed by first being analyzed as constituent parts of a whole, then synthesized as a whole, and finally interpreted. Ultimately, the goal of those wishing to leverage the power of computing—through the display of graphical data—in their daily work is to convert data into actionable information in an efficient and cost-effective manner.

For example, in medical applications, presenting a medical image of an organ on the computer display enables physicians to diagnose the medical problem afflicting this organ, while the computer system cannot extract any useful medical data (information) from this image.

In engineering applications, displaying a set of images of a collapsing building or an explosion can help engineers analyze the reason behind this collapse or explosion while the computer system cannot provide any helpful information in this regard.

The present invention solves the aforementioned problem by introducing an innovative technique that enables the computer system to recognize the two or three-dimensional graphical data on its display in an informative manner. Accordingly, the computer system becomes able to extract useful information from this data in a manner that matches or even exceeds a human's ability.

### SUMMARY

The technique of the present invention is based on isolating graphical data into well-defined geometric zones tagging each zone (or object) with a unique ID. The computer system then divides said zones into a plurality of hidden identical squares (or cells) located (defined) on a hidden mesh grid in a matrix-like fashion. This matrix-like grid creates a virtual “data landscape” of cells that encapsulates the entire area seen on the computer display with all its defined constituent zones

A number of individual matrices are then formed, where each one represents the location of one of said zones or objects relative to the data landscape that bounds the graphical data in its entirety.

A “master matrix” is subsequently formed—in cases where more than one zone has been defined—representing the locations of all said zones or objects geographically relative to each other and relative to the aforementioned data landscape.

Each matrix cell includes one unique ID tag (or more than one ID if different zones overlap, similar to overlapping Venn diagrams) belonging to (or identifying) one (or more) of said zones or objects; in the event of an empty cell, the cell is then tagged with a zero (“0”).

This system (similar to character encoding) of tagging with characters adds intelligence to the data that allows the computer to understand the distal and proximal relationships of shapes as opposed to simply perceiving points and lines.

At this level, the computer system can help the user to extract information from the data that is graphically displayed on the computer. This graphical data can be pictures, drawings, 3D models, or the like. This can be achieved by communicating with the computer system using the data (intelligence) provided in the matrices, instead of using the visual parameters of the graphical data.

Using the technique of the present invention enables the computer system to help the user to explore, analyze, or evaluate the characteristics of the virtual data on the computer display which can be a helpful tool for many applications or sciences such as biology, physics, or chemistry.

In addition to this, the computer system can aid the user to re-design or re-create the presented visual data on the computer display which can be an extremely useful tool for many engineering, industrial, or manufacturing applications.

In IT applications, many software suites such as AutoCAD, Microsoft PowerPoint, or 3ds Max become able to provide the user with automated drawings or models based on the user's requirements or preferences without the need of the manual effort of the user to achieve such tasks.

### BRIEF DESCRIPTION OF THE DRAWINGS

FIG. 1.1 is an example of graphical data in the form of an image or drawing presented on the computer display.

FIG. 1.2 is assigning a unique ID for each drawn polygon or defined zone of the graphical data.

FIG. 1.3 is dividing the graphical data into a plurality of hidden squares (or cells) on the computer display.

FIGS. 1.4 to 1.7 are individual matrices representing the location of each defined zone relative to the boundary of the graphical data.

FIG. 1.8 is a master matrix representing the locations of all defined zones relative to the boundary of the graphical data.

FIG. 2.1 is an example for graphical data representing a building plan presented on the computer display.

FIG. 2.2 is assigning a unique ID for each drawn polygon or defined zone of the building plan.

FIG. 2.3 is dividing the graphical data of the building plan into a plurality of hidden squares.

FIGS. 2.4 to 2.9 are individual matrices representing the location of each defined zone of the building plan relative to the site boundary.

FIG. 2.10 is a master matrix representing the locations of all defined zones of the building plan relative to the site boundary.

FIG. 3.1 is an example of graphical data of a GIS image of a site presented on the computer display.

FIG. 3.2 is defining the zones of the GIS image by drawing a polygon on top of each object of the GIS image.

FIG. 3.3 is dividing the GIS image into a plurality of hidden squares on the computer display.

FIG. 3.4 is a master matrix representing the locations of all defined zones of the GIS image relative to the site boundary.

FIG. 4.1 is an example for graphical data of a 3D model comprised of a number of objects presented on the computer display.

FIG. 4.2 is the top view of the different objects of the 3D model presented on the computer display.

FIG. 4.3 is assigning a unique ID for each object of the graphical data of the 3D model on the computer display.

FIG. 4.4 is dividing the top view of the 3D model into a plurality of hidden squares on the computer display.

FIGS. 4.5 to 4.8 are four layers of a master matrix representing the objects of the 3D model at each varying height of an object.

FIG. 5 is a diagram illustrating the main steps of the present invention to convert graphical data into a usable form.

### DETAILED DESCRIPTION

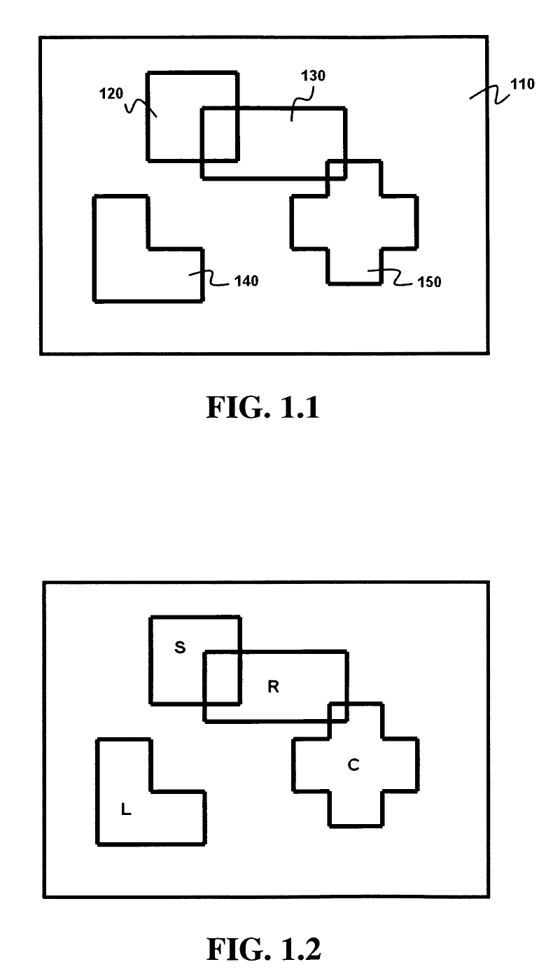

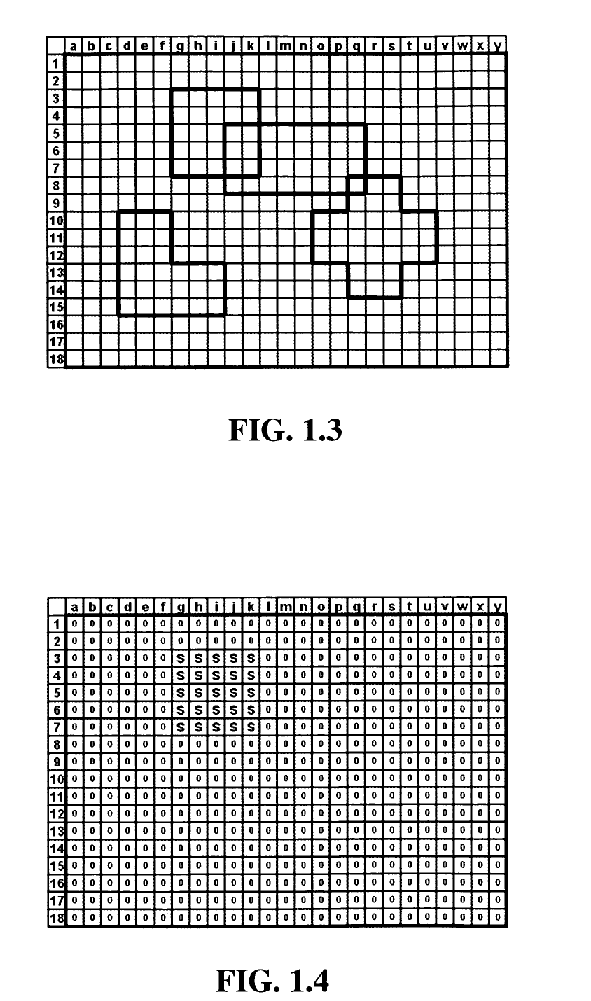

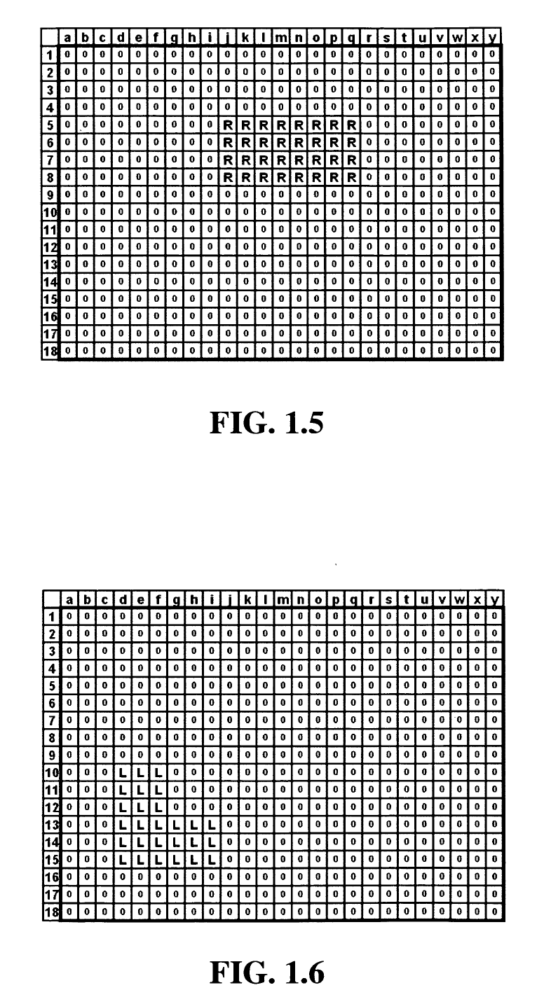

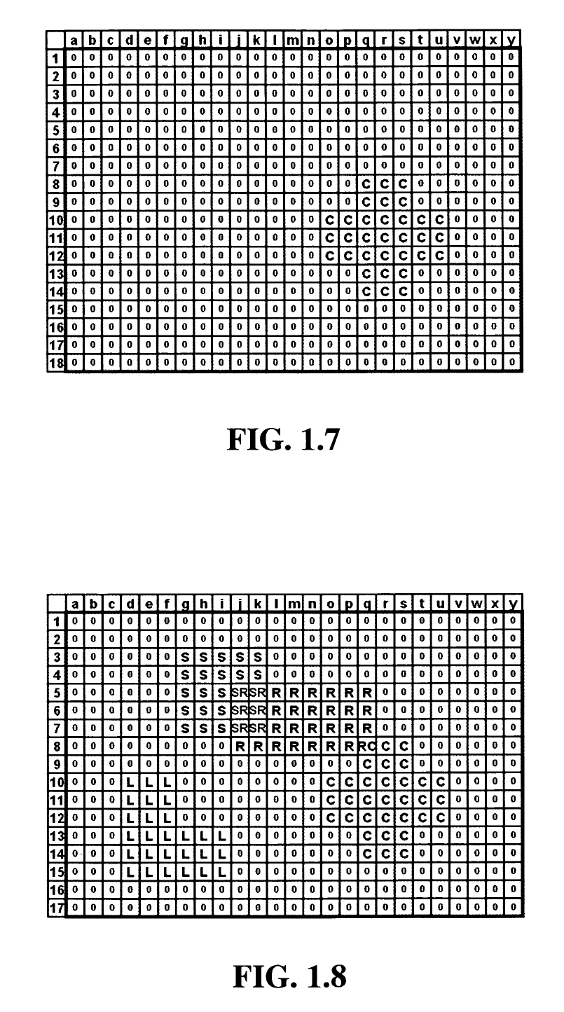

FIG. 1.1 illustrates an example of graphical data in the form of an image or drawing presented on the computer display 110. This data is comprised of four shapes; the first shape is in the form of a square 120, the second shape is in the form of a rectangular 130, the third shape is in the form of an L 140, and the fourth shape is in the form of a cross 150.

The first technical step of the present invention is to define the zones of the presented graphical data on the computer display to the computer system. This can be achieved by allowing the user to draw a polygon on top of each shape of the data outlining its boundary into a distinct and discrete zone.

This step is especially important when the shape(s) comprising the graphical data are not defined to the computer system as separate, distinct and discrete objects. If the graphical data is already defined to the computer system as separate objects, as in the case of some software applications, then the user does not need to perform this step.

The second technical step of the present invention is to enable the computer system to assign a unique ID for each drawn polygon or defined zone of the graphical data. For example, FIG. 1.2 illustrates assigning “S” for the square-shape, “R” for the rectangle-shape, “L” for the L-shape, and “C” for the cross-shape.

The third technical step of the present invention is to enable the computer system to divide the graphical data into a plurality of hidden squares (or cells) as illustrated in FIG. 1.3. As shown in this figure, this type of dividing creates a mesh grid that is further characterized by a number of columns that are symbolized in English letters, and a number of rows that are symbolized in numerals, creating the aforementioned data landscape consisting of a “hollow” matrix.

The fourth technical step of the present invention is to enable the computer system to form a number of individual matrices, where each one of these individual matrices represents the location of one of the defined zones relative to the boundaries of the graphical data landscape.

For example, FIG. 1.4 illustrates an individual matrix representing the square-shape, FIG. 1.5 illustrates an individual matrix representing the rectangle-shape, FIG. 1.6 illustrates an individual matrix representing the L-shape, and FIG. 1.7 illustrates an individual matrix representing the cross-shape.

As shown in the previous figures, each cell of the individual matrices contains an ID of one of the defined zones of the graphical data, or contains zero where the figure zero represents an empty cell.

The fifth technical step of the present invention is to enable the computer system to form a master matrix as illustrated in FIG. 1.8. This master matrix represents the locations of all defined zones relative to the boundary of the graphical data.

As shown in the previous figure, each cell of the master matrix contains one or more IDs of the defined zones of the graphical data, or contains zero where the figure zero represents an empty cell.

At this level, the computer system can now help the user to analyze the presented graphical data on the computer display. For example, if the user needs to calculate the area of each zone of the graphical data, the user communicates with the computer system requesting to count the cells of the individual matrices that contain “S”, “R”, “L”, and “C”.

If the user needs to measure the perimeter of each zone of the graphical data, the user communicates with the computer system requesting to count cells in each individual matrix that contain “S”, “R”, “L”, or “C”, and also are cells that are adjacent to another empty cell that contains “0”.

If the user needs to define the areas or spots of overlapping between each two zones of the graphical data, the user communicates with the computer system requesting to define the cells of the master matrix that contain more than one ID.

In this case, it is possible to make the computer system color the areas or spots of the graphical data on the computer display that are associated with the defined cells as an indication of this type of overlapping.

If the user needs to define the perimeter of each zone that has a direct view to the bottom line of the graphical data boundary, the user communicates with the computer system requesting to find the first cell in each column of the master matrix that includes “S”, “R”, “L”, or “C” starting from the bottom-most column.

In this case, the computer system will identify the following cells; 15d, 15e, 15f, 15g, 15h, 15i, 8j, 8k, 8l, 8m, 8n, 12o, 12p, 14q, 14r, 14s, 12t, and 12u. The computer system can also color the parts (cells) on (in) the zones that are associated with this type of direct viewing.

The previous example of the graphical data indicated a small number of geometrical shapes, however, it is possible to apply the present invention on a great number of organic-shapes, free-shapes, or the like using the same described steps.

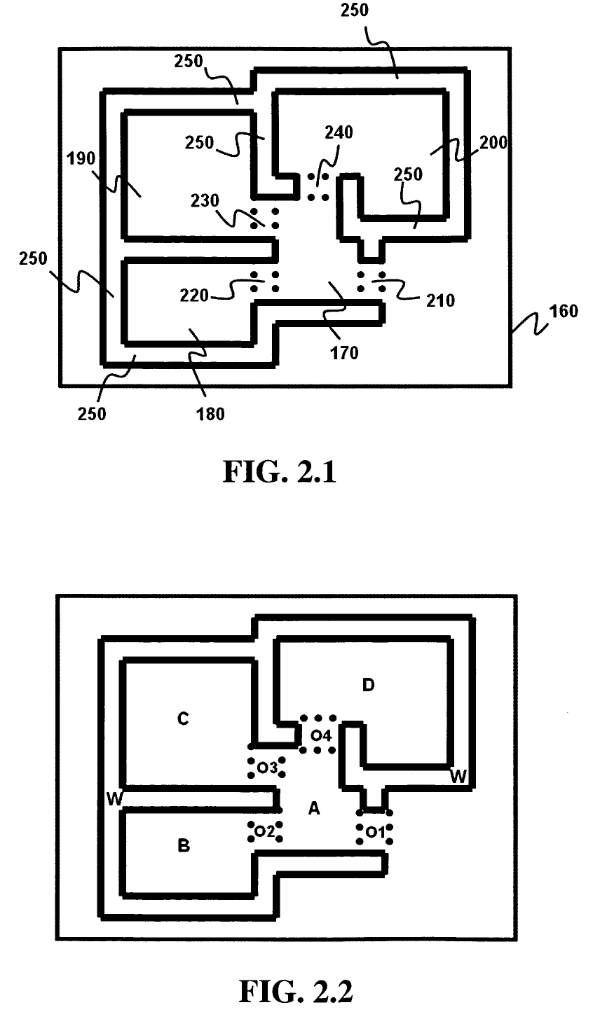

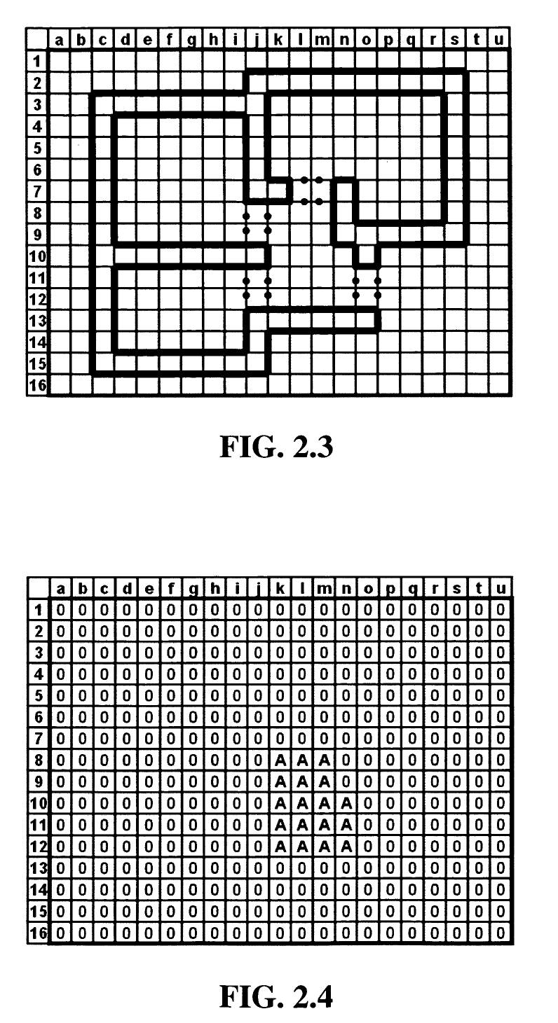

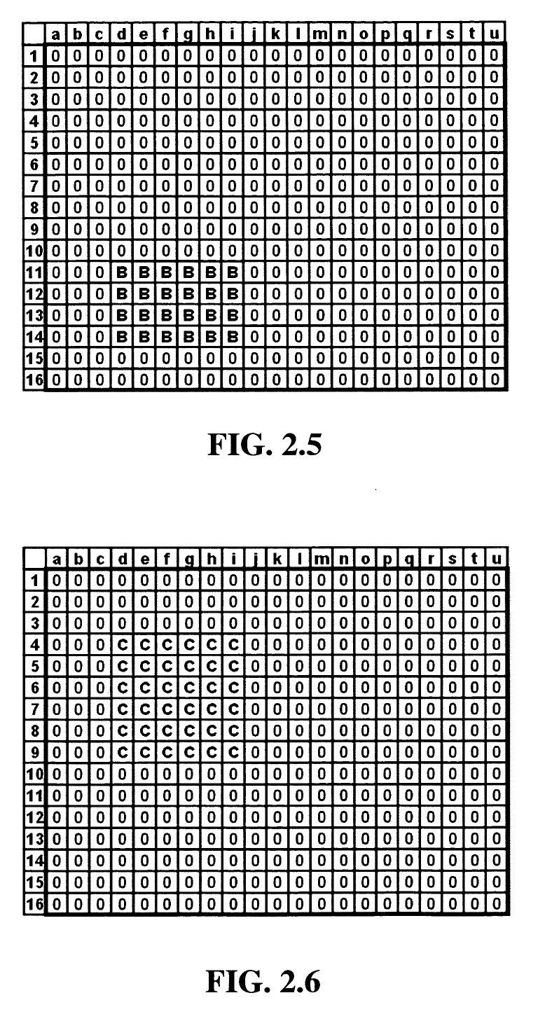

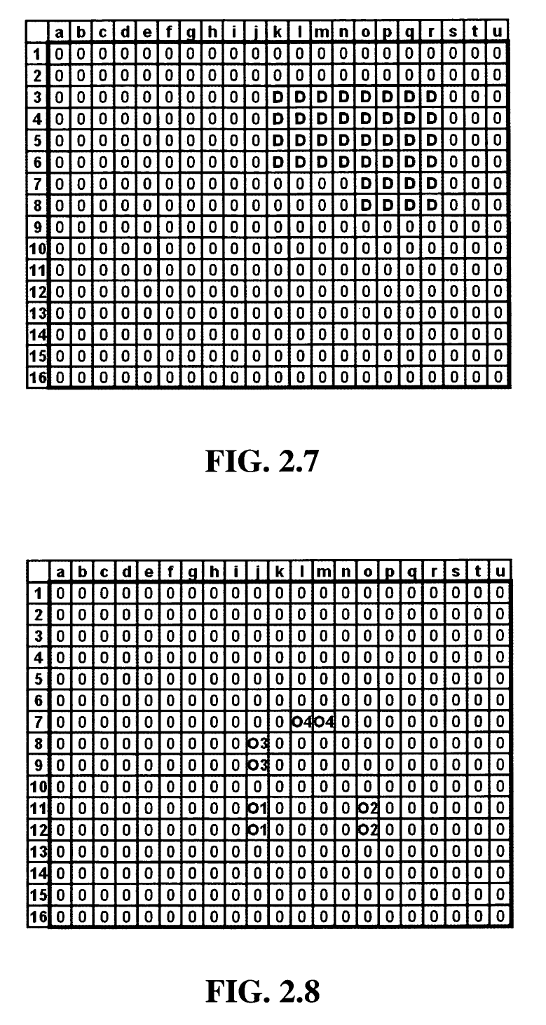

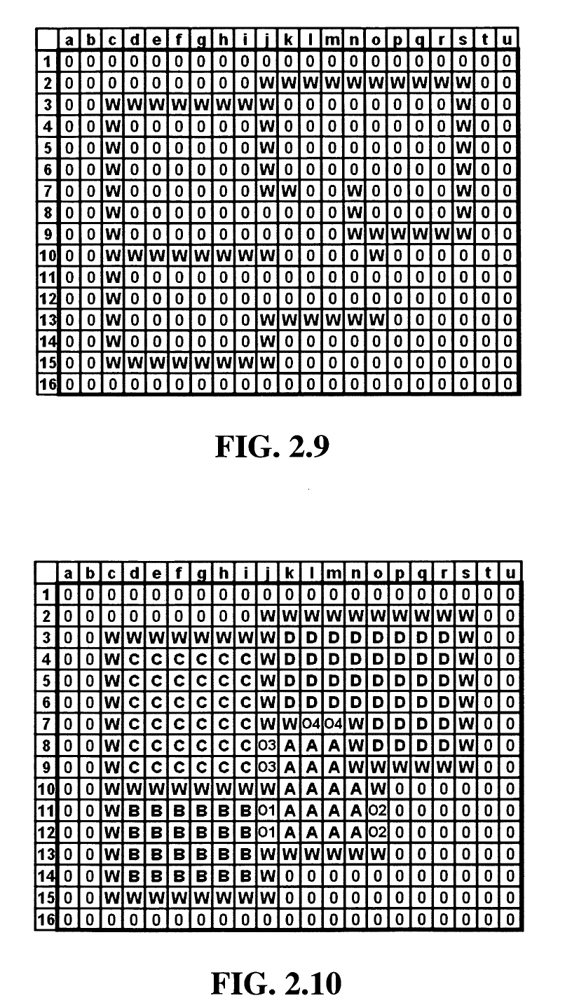

FIG. 2.1 illustrates another example for graphical data representing a building plan presented on a computer display. The building plan is comprised of: a site boundary (or data landscape) 160, a first room 170, a second room 180, a third room 190, a fourth room 200, a first opening 210, a second opening 220, a third opening 230, and a fourth opening 240, in addition to a number of walls 250.

To apply the present invention on this example, the previous described steps will be followed. For example, the first step is to define the zones of the building plan by allowing the user to draw a polygon on top of each zone of the building plan on the computer display.

The second step is to enable the computer system to assign a unique ID for each drawn polygon or defined zone of the building plan. As illustrated in FIG. 2.2, the computer system assigned “A” for the first room, “B” for the second room, “C” for the third room, “D” for the fourth room, “O1” for the first opening, “O2” for the second opening, “O3” for the third opening, “O4” for the fourth opening, and “W” for the walls.

The third step is to enable the computer system to divide the graphical data of the building plan into a plurality of hidden squares as illustrated in FIG. 2.3. As shown in this figure, this type of dividing the building plan created a number of columns that are symbolized in English letters, and a number of rows that are symbolized in numerals.

The fourth step is to enable the computer system to form a number of individual matrices, where each one of these individual matrices represents the location of one defined zone of the building plan relative to the site boundary.

FIG. 2.4 illustrates the individual matrix that represents the first room, FIG. 2.5 illustrates the individual matrix that represents the second room, FIG. 2.6 illustrates the individual matrix that represents the third room, and FIG. 2.7 illustrates the individual matrix that represents the fourth room.

FIG. 2.8 illustrates the individual matrix that represents the first opening, the second opening, the third opening, and the fourth opening. It is possible to form four individual matrices for the four openings instead of the one matrix of FIG. 2.8. The last individual matrix is illustrates in FIG. 2.9 representing the walls.

The fifth step is to enable the computer system to form the master matrix of the building plan as illustrated in FIG. 2.10. This master matrix represents the locations of all defined zones of the building plan relative to the site boundary.

In this example, the cells of the individual matrices and the master matrix that include a “0”, represents a spot of the building site that does not have any defined zone. In other words, it represents a spot of the land that does not have any buildings on it.

At this level, the computer system can help the user to analyze the design of this building plan. For example, if the user needs to identify the interior walls that separate each pair of adjacent rooms in the building plan, the user communicates with the computer system requesting to identify the cells of the master matrix that include a “W” and are also adjacent to two cells from left and right, or from top and bottom, in addition to also including different IDs than “0” or “W”.

According to this request, the computer system will identify the following cells: 4j, 5j, 6j, 7k, 7n, 8n, 10d, 10e, 10f, 10g, 10h, 10i, and 10j as cells representing the walls that separate between each two rooms of the building. It is possible in such case to make the computer system color these areas of the building plan on the computer display as an indication for interior walls, or process some alternative tagging to further allow actionable events.

If the user needs to calculate the length of the exterior walls of the building, the user communicates with the computer system requesting to count the cells of the master matrix that that are adjacent to a cell tagged with a “0”.

According to this request, the number of these cells will be “53U”, where the value 55 represents the number of cells that satisfy the previous request, and the value “U” represents the length of the hidden square side, which is defined to the computer system.

If the user needs to calculate the area of the building site that can be used for landscaping, the user communicates with the computer system requesting to count the number of cells that are tagged with a “0”.

According to this request, the landscaping area will be “98U*”, where the value 98 is the number of the cells that contain “0” which represent the parts of land suitable for landscaping, and the value “U*” is the area of one of the hidden squares which represents a specific square footage according to the drawing scale of the building plan.

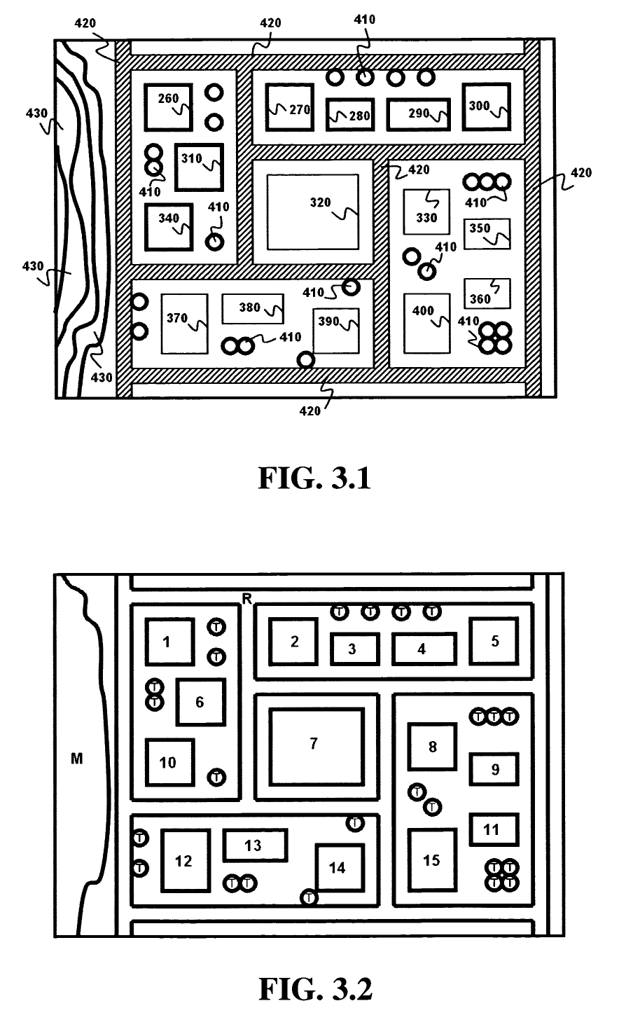

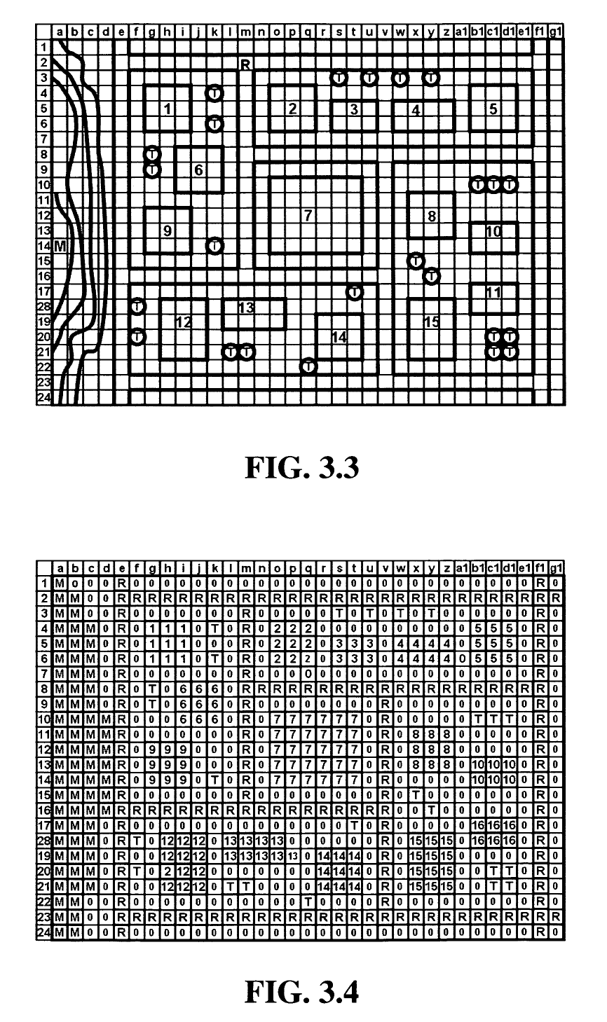

FIG. 3.1 illustrates another example of graphical data of a GIS image of a site presented on a computer display. The GIS image is comprised of a number of rectangles representing 15 buildings 260 to 400, a plurality of circles representing trees 410, striped spots representing streets or roads 420, and a plurality of contour lines representing a mountain 430.

FIG. 3.2 illustrates the first step of the present invention which is defining the zones of the GIS image by drawing a polygon on top of each object of the GIS image. As shown in this figure, the drawn polygon that defines the mountain is only defining the outlines of the mountain since there is no need to define the details of the mountain's contour lines.

FIG. 3.2 also illustrates the second step of the present invention which is assigning a unique ID for each drawn polygon or defined zone of the GIS image. In this case, the user assigned numbers “1 to 15” for the buildings, “T” for the trees, “R” for the roads, and “M” for the mountain.

FIG. 3.3 illustrates the third step of the present invention which is dividing the GIS image into a plurality of hidden squares. The fourth step of the present invention is forming the individual matrices. However, the user's requirements in this example will not utilize the individual matrices; accordingly they are not shown with the figures.

FIG. 3.4 illustrates the fifth step of the present invention which is forming the master matrix. As shown in this figure, each circle that represents a tree is approximated to one of the hidden squares, and the mountain's outlines are also approximated to a number of the hidden squares.

At this level, the computer system can help the user to analyze the site characteristics of the GIS image, and enable him/her to make accurate decisions regarding any future re-designing, or changing of the site features.

For example, if the user needs to define the spots in this site that can be used for planting trees to block the direct view between building 7 and building 8, the user communicates with the computer system requesting to identify the cells that include “0” and in the same time are located between building 7 and building 8.

The computer system will then identify cells 11u, 11w, 12u, 12w, 13u, and 13w as suitable spots for the requested trees planting. In this case it is possible to make the computer system color these spots or cells on the computer display as an indication for such requested planting.

If the user needs to measure the distance between any two points or objects of the GIS site image, the user communicates with the computer system specifying the two points that s/he needs to measure the distance between them.

For example, if the user needs to measure the distance between the southeast corner of building 1 and the northwest corner of building 15, the user communicates with the computer system requesting to count the horizontal and vertical cells between buildings 1 and 15 representing the catheti of a right-triangle where its hypotenuse represents the value of the distance between the southeast and northwest corners as calculated with the Pythagorean theorem.

Accordingly, the number of the requested horizontal cells is equal to 14, the number of the requested vertical cells is equal to 11, and the value of the hypotenuse is equal to 17.8 U, where U is the length of the hidden square side.

The previous two examples of the present invention are two-dimensional applications, however, the same steps of the present invention can be applied on three-dimensional applications as described in the following example.

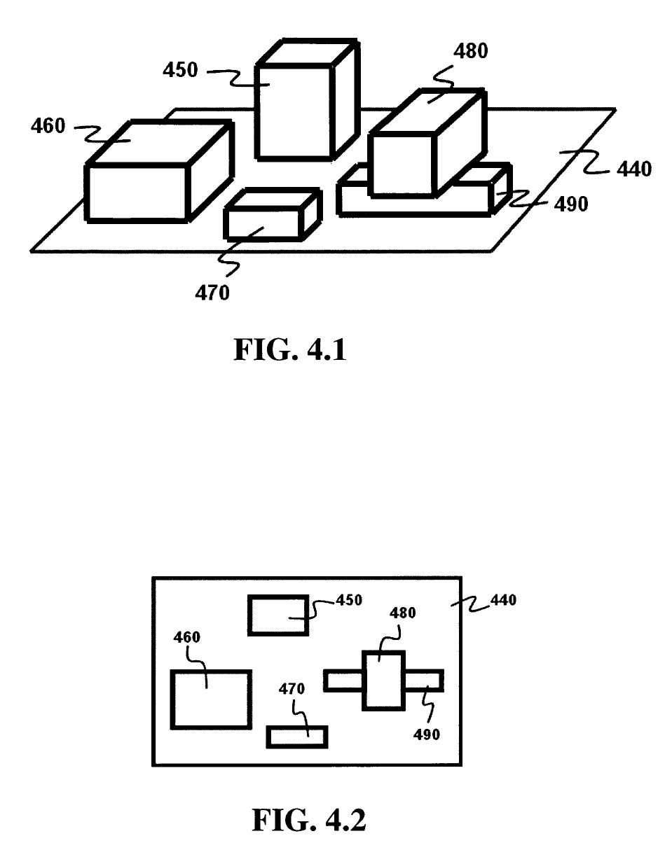

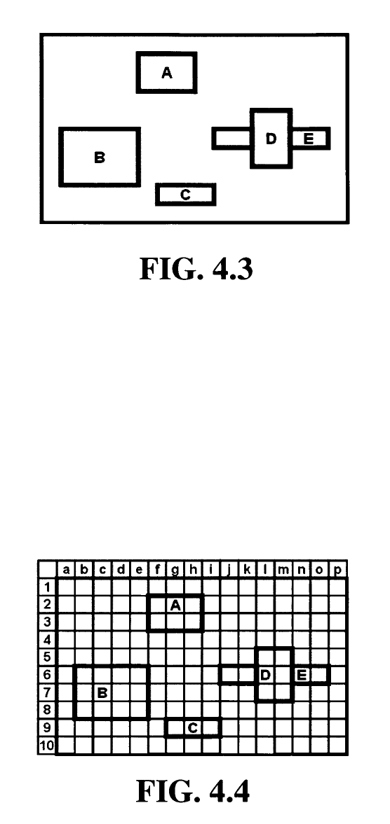

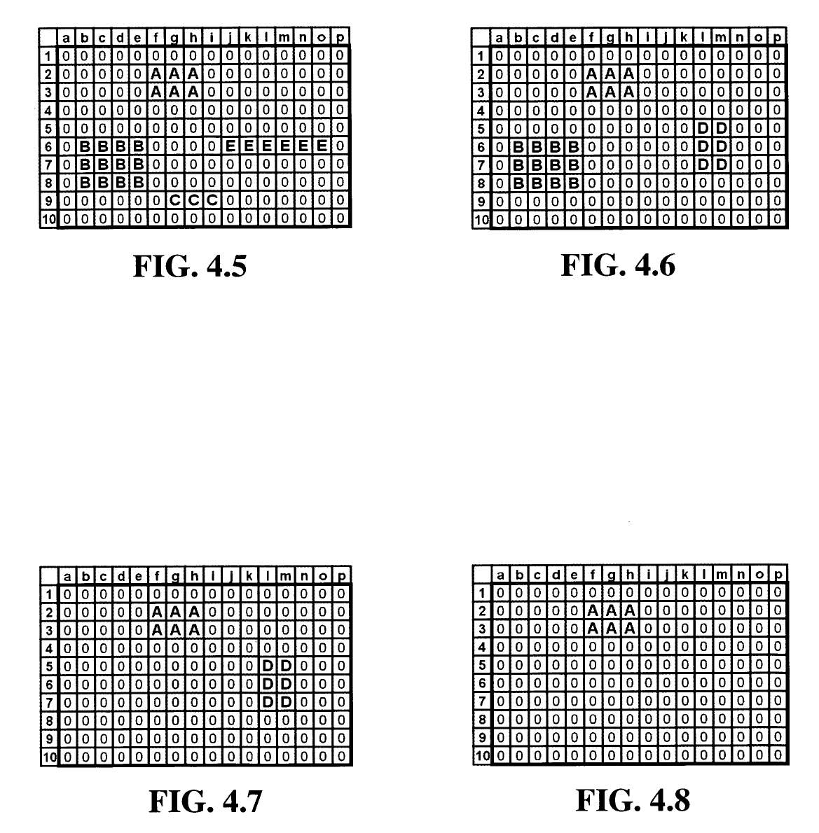

FIG. 4.1 illustrates graphical data of a 3D model presented on the computer display, where this 3D model is comprised of a horizontal plane 440, a first object 450, a second object 460, a third object 470, a fourth object, 480, and a fifth object 490. FIG. 4.2 illustrates the top view of this 3D model.

The first step of the present invention is to define the different zones or objects of the 3D model, where in this case all the objects of the 3D model are assumed to be defined to the computer system during their modeling or construction.

FIG. 4.3 illustrates the second step of the present invention where a unique ID is assigned for each object of the 3D model. FIG. 4.4 illustrates the third step of the present invention where the top view of the 3D model is divided into a plurality of hidden squares.

The fourth step of the present invention is to form the individual matrices of the 3D model, where these individual matrices are not shown with the figures since the user's requirements will not utilize them in this example.

The fifth step of the present invention is to form the master matrix where in such 3D applications the master matrix, and also the individual matrices are comprised of a number of layers where each layer is set at each varying height of an object of the 3D model.

For example, FIG. 4.5 illustrates the first layer of the master matrix representing the 3D model at the level height of objects C and E, where these two objects have the same height. FIG. 4.6 illustrates the second layer representing the 3D model at the level height of object B. FIG. 4.7 illustrates the third layer representing the 3D model at the level height of objects D. FIG. 4.8 illustrates the fourth or the last layer representing the 3D model at the level height of objects A.

At this level, the computer system can help the user to analyze the visual characteristics of the 3D model. For example, if the user needs to calculate the areas of the existing objects at a specific height, the user communicates with the computer system requesting to count the cells that contain A, B, C, D, or E in the layer of the master matrix that represents this specific height.

If the user needs to rank the objects of the 3D model according to their heights, the user communicates with the computer system requesting to count the number of layers that include A, B, C, D, and E. In this case, there are 4 layers include A, 2 layers include B, 2 layers include D, one layer includes C, and one layer includes E.

Generally, the main difference between applying the present invention on the three-dimensional applications than the two-dimensional applications is the appearance of the layers in both of the individual matrices and the master matrix as described in the previous example.

However, forming the layers of the individual matrices and the master matrix is also used when the ID of the defined zone has more than one piece of information. For example, each layer may represent one attribute of said defined zone while the entire layers represent the entire attributes of said defined zone.

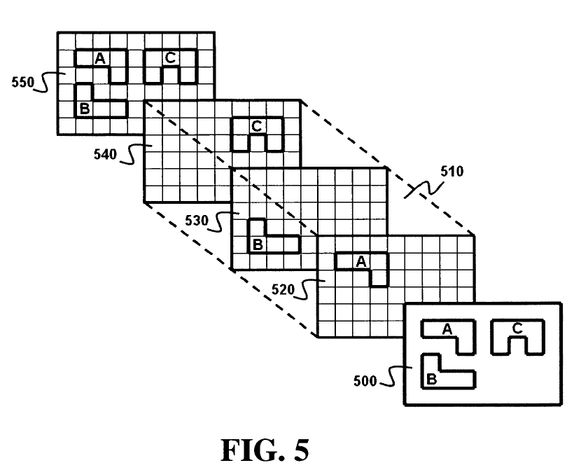

FIG. 5 illustrates the main steps of the present invention, as shown in this figure, graphical data 500 is presented on a computer display, a number of individual matrices 510 are formed where each individual matrix 520, 530, and 530 represents one zone of the graphical data, and a master matrix 520 is subsequently formed to represent all zones of the graphical data.

Overall, it is important to note that the first step of the present invention which is defining the different zones or objects of the graphical data can be done by the computer system without the manual input of the user. For example, in some medical imaging applications the computer system can identify the different zones of the medical image based on the relative of opacity of each zone of the image.

Also, in the GIS applications the computer system can define the zones or objects of the GIS image based on the different colors of each different zones or objects. For example, green may identify trees, brown may identify mountains, dark grey may identify streets, and red may identify buildings.

Finally, it is important to note that if the present invention of the graphical data mapping technique becomes commercially available, it is believed that developers of various software would come up with innumerable additional uses and applications.

1. A graphical data mapping technique that enables the computer system to recognize and analyze the presented graphical data on the computer display wherein said graphical data mapping technique comprising the steps of;
a) defining the zones of said graphical data by allowing the user to draw a polygon on top of each one of said zones on the computer display.
b) assigning a unique ID for each drawn polygon or defined zone of said graphical data on the computer display.
c) dividing said graphical data into a plurality of hidden squares creating a hidden mesh grid.
d) forming a number of individual matrices, where each one of said individual matrices represents the location of one of said defined zones relative to the boundary of said graphical data, where each cell of said individual matrices represents one of said hidden squares, and contains an ID of one of said defined zones, or contains zero where the figure zero represents an empty cell.
e) forming a master matrix to represent the locations of said defined zones relative to the boundary of said graphical data, where each cell of said master matrix represents one of said hidden squares, and contains one or more ID of one or more zones of said defined zones, or contains zero where the figure zero represents an empty cell.

2. The graphical data mapping technique of claim 1 wherein said graphical data is a picture.

3. The graphical data mapping technique of claim 1 wherein said graphical data is an image.

4. The graphical data mapping technique of claim 1 wherein said graphical data is a drawing.

5. The graphical data mapping technique of claim 1 wherein said zones are in the form of geometrical shapes.

6. The graphical data mapping technique of claim 1 wherein said zones are in the form of freeform shapes.

7. The graphical data mapping technique of claim 1 wherein said graphical data is a medical image where the computer system identifies said zones by utilizing the relative opacity of each part or spot of said medical image.

8. The graphical data mapping technique of claim 1 wherein said graphical data is an image where the compute system identifies said zones by utilizing the different color of each area or spot of said image.

9. The graphical data mapping technique of claim 1 wherein said graphical data is a two or three-dimensional drawing or model whereas said zones are already defined to the computer system during the construction of said two or three-dimensional drawing or model.

10. The graphical data mapping technique of claim 1 wherein the user provides a manual input to the computer system to assign said unique IDs.

11. The graphical data mapping technique of claim 1 wherein the computer system assigns said unique IDs without a manual input from the user.

12. The graphical data mapping technique of claim 1 wherein said hidden squares are hidden identical squares.

13. The graphical data mapping technique of claim 1 wherein said hidden squares are hidden rectangle, circles, or other polygons.

14. The graphical data mapping technique of claim 1 wherein said hidden mesh grid is comprised of a number of columns and rows.

15. The graphical data mapping technique of claim 1 wherein said graphical data is a two-dimensional graphical data.

16. The graphical data mapping technique of claim 1 wherein said graphical data is a three-dimensional graphical data.

17. The graphical data mapping technique of claim 1 further each one of said individual matrices and said master matrix is comprised of a number of layers which means a number of matrices.

18. The graphical data mapping technique of claim 16 further said individual matrices and said master matrix are comprised of a number of layers, which means a number of matrices, and each layer of said layers is set at each varying height of an object of said three-dimensional graphical data.

19. The graphical data mapping technique of claim 17 wherein each one of said layers represents one attribute of said defined zone while the entire group of said layers represent the entire attributes of said defined zone.

20. The graphical data mapping technique of claim 18 wherein two or more of said objects have the same height.
